(19) United States
(12) Patent Application Publication
(10) Pub. No.: US 2025/0271080 A1
(43) Pub. Date: Aug. 28, 2025

(54) VALVE HEATING ARRANGEMENT

(71) Applicant: Goodrich Corporation, Charlotte, NC (US)

(72) Inventors: Piotr Jacek KROCZEK, Nieciszów (PL); Lukasz TUREK, Wroclaw (PL)

(21) Appl. No.: 19/037,786

(22) Filed: Jan. 27, 2025

(30) Foreign Application Priority Data
Feb. 23, 2024 (EP) 24461534.0

(51) Int. Cl. F16K 49/00; H05B 3/00

(52) U.S. Cl. CPC F16K 49/00; H05B 3/0033; H05B 2203/032

(57) ABSTRACT

A valve heating arrangement includes a valve housing body comprising a heat conductive material and which incorporates one or more infrared heater elements mounted into one or more enclosed recesses provided on or integrally formed with a valve housing body, the one or more recesses having at least one wall defined by a closure of transparent material selected to allow infrared radiation of a first wavelength range to pass therethrough but to block passage of infrared radiation of a second, different, wavelength range from passing therethrough. The arrangement further includes means for providing power to the one or more infrared heating elements to emit infrared radiation across the first and second wavelength ranges.

### CROSS-REFERENCE TO RELATED APPLICATIONS

This application claims the benefit of European Patent Application No. 24461534.0 filed Feb. 23, 2024, the disclosure of which is incorporated herein by reference in its entirety.

### TECHNICAL FIELD

The present disclosure is concerned with providing heating for valves and valve components e.g. to prevent freezing.

### BACKGROUND

Valves of many types are known to regulate the flow of fluid through a system. Such valves can be manual or motorized. Mechanical, hydraulic and electrical valves are known and used in many fields. Often, such valves and associated pipes are required to operate in extreme environments and are required to be able to continue to operate reliably in environments where e.g. contamination, vibration, pressure and or temperatures can impact operation. One field of application where the valve components are subjected to particularly low temperatures is in the aerospace field. Valves are used to drain fluid from water systems in the aircraft or to drain water that has accumulated in parts of the aircraft such as the fuel tank. Hydraulic valves are also used to control moveable parts of the aircraft such as flight control panels. Components such as water pipes and valves designed for aerospace applications often face many unique challenges. One of the main challenges is high altitude operation with ambient temperatures around −45° C. (−50° F.). At such temperatures, water in or around the valve parts can freeze and prevent reliable operation of the valve. For this reason, many valves require some form of heating to prevent water in or on the valve from freezing.

Typically, silicone heaters are used since these can be formed as flexible sheets or sleeves and fitted around the parts of the valve that require heating.

Although silicone heaters provide an effective and simple solution, silicone has fairly low mechanical properties and so can be damaged during installation or during normal use of the valve and may need to be replaced frequently. Further, the known silicone heaters are provided as a layer around the valve/pipes. The provides very localised heating. Further, this results in an overall increase of the size of the valve/pipes and therefore requires more space for installation. In aircraft, and other applications where space is limited, this can be disadvantageous.

There is, therefore, a need for a simple way of providing heating to valves that avoids these problems.

### SUMMARY

According to this disclosure, there is provided a heating arrangement for a valve, comprising a valve housing body comprising a heat conductive material and which incorporates one or more infrared heater elements mounted into one or more enclosed recesses provided on or integrally formed with a valve housing body, the one or more recesses having at least one wall defined by a closure of transparent material selected to allow infrared radiation of a first wavelength range to pass therethrough but to block passage of infrared radiation of a second, different, wavelength range from passing therethrough, the arrangement further including means for providing power to the one or more infrared heating elements to emit infrared radiation across the first and second wavelength ranges.

The first wavelength range may be in the near- or short-wave infrared radiation range, and the second wavelength range may be in the mid- or long-wave infrared radiation range, and

One or more of the recesses may be provided in extensions or flanges at the corners of the housing body. One or more recesses may be provided in existing space at the top or bottom of the housing body.

Two infrared heater elements may be provided in each recess.

In one example, the housing body and heating elements and recesses are arranged as two mirrored subsystems, each having its own power supply.

Also provided is a valve assembly comprising a valve heating arrangement as defined above, an inlet port and an outlet port arranged to define a flow passage therebetween through the valve housing, and a moveable valve element located in the flow passage and movable relative to the valve housing to regulate flow through the flow passage from the inlet port to the outlet port.

### BRIEF DESCRIPTION OF THE FIGURES

Examples of the valve heating arrangement of the disclosure will be described below with reference to the drawings. It should be noted that variations are possible within the scope of the claims.

The arrangement will be described with particular reference to valves used in aerospace, but the inventive concept can be equally applied to valves used in other applications where heating is required and the scope of the invention is not limited to any particular application or type of valve.

FIG. 1 shows an example of a typical valve provided with a known silicone heater.

FIG. 2 shows an example of a heating arrangement according to this disclosure.

FIG. 3 shows a detail of an example of a heating arrangement according to the disclosure.

FIG. 4 shows a part-exploded view of the example of FIG. 2.

FIG. 5 shows a part-exploded view of the detail of FIG. 3.

FIG. 6 shows an example of the heater arrangement incorporated into a valve assembly.

FIG. 7 is provided to explain heat generation in an arrangement according to the disclosure.

FIG. 8 is provided to further explain the heating effect in an arrangement according to the disclosure.

### DETAILED DESCRIPTION

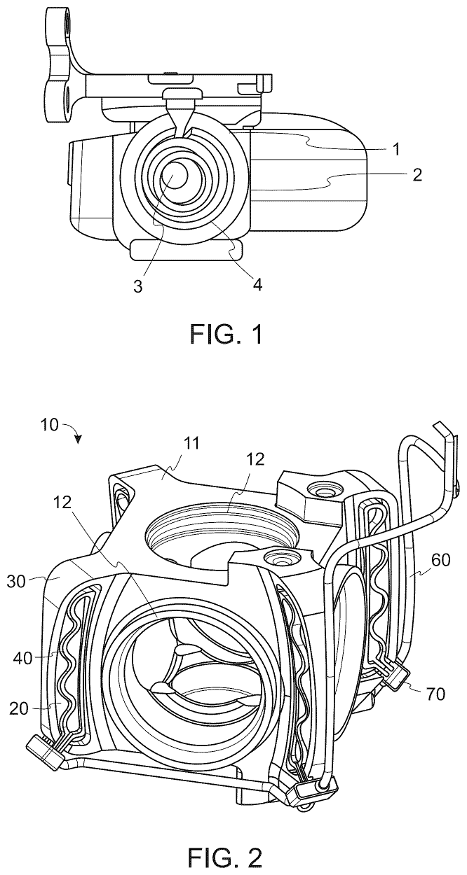

With reference to FIG. 1, a conventional valve heating arrangement will be described by way of background.

A typical valve comprises a valve body 1 having a number of ports 2 and defining a fluid flow passage 3 therethrough between the ports. The valve regulates the flow of fluid in different ways depending on the type of valve, but essentially a valve component e.g. a ball, moves relative to the valve body to open and close the fluid flow passage as required. The present invention is not limited to any particular type of valve.

In the conventional arrangement, where the valve is at risk of freezing at low temperatures, silicone heater elements 4 are wrapped around the outside of the valve parts.

As can be seen, this adds to the overall dimensions of the valve and, further, the heater elements may be vulnerable to damage. Furthermore, the heater elements provided a very limited and localised heating effect.

The heating arrangement of the present disclosure comprises a valve housing body 11 comprising a heat conductive material and which incorporates one or more infrared heater elements 40 mounted into one or more recesses 20 provided on or integrally formed with the valve housing body, the one or more recesses having at least one wall defined by a closure 50 of transparent material selected to allow infrared radiation of a first wavelength range to pass therethrough but to block passage of infrared radiation of a second, different, wavelength range from passing therethrough, the arrangement further including means 60, 70, 80 for providing power to the one or more infrared heating elements to emit infrared radiation within the first and second wavelength ranges.

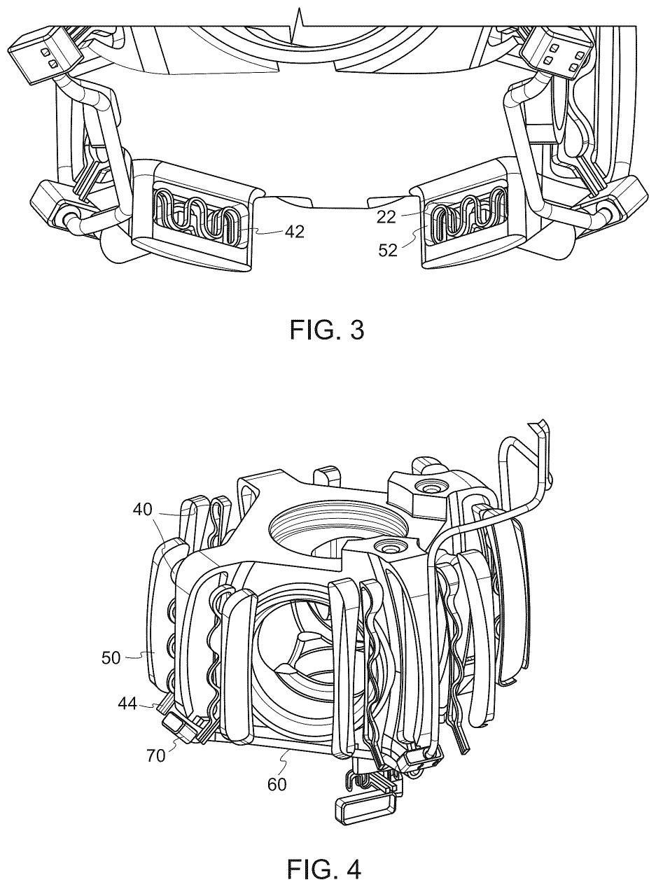

An example of the heater arrangement according to the disclosure is shown in FIGS. 2 and 3. The arrangement includes a valve housing 10 having a body 11 of heat conductive material e.g. steel or other conductive metal. The valve housing 10 is configured to house a movable valve part and to be connected, at ports 12, via e.g. connectors, to fluid pipes 13 and/or plugs 14 (as can be seen in FIG. 6). The valve housing, housing the movable valve part, is arranged to be connected in a fluid system in a known manner such that the valve can allow or prevent fluid flowing through the pipes 13 to pass the valve. The example shown is a ball valve, where the movable element would be a ball, with a passage defined therethrough, arranged to rotate within the valve housing such that the passage aligns with the ports connected to pipes 13, in an open position, or the ball body blocks fluid flow through the pipes in a closed position. This is just one type of known valve arrangement. Other types of valve are known, not described here, to which the heater arrangement of this disclosure could be applied.

The valve housing 10 is provided with one or more recesses 20 to house the infrared heater elements. The recesses 20 may be provided in flanges or extensions of the valve housing, referred to herein as heating pads 30. In the example shown, a heating pad 30 is provided at each of four corners of the valve housing but other numbers of and locations for heating pads can also be envisaged. Further, the heating pads 30 may be provided as separate parts which are affixed to the valve housing or may be manufactured integrally with the valve housing e.g. by additive manufacturing/3D printing processes.

One or more electric infrared heaters 40 is located in each recess 20. In the example shown, each recess has two heaters so as to emit radiation from two sides of the recess. A single heater, or more than two heaters could also be provided.

The recess 20 is formed as a closed space housing the heater(s), with at least one wall portion formed of a transparent, heat-resistive material 50 such as glass or some other material that absorbs some infrared radiation e.g. mid-wave or long-wave infrared radiation, but allows other infrared radiation e.g. near or short-wave infrared radiation to pass therethrough. Polycarbonates are a group of thermoplastic materials that also have these properties. In the example shown, the recesses are defined by two opposing walls of such transparent material.

The heaters are arranged such that power can be provided to them from outside the recess, to cause the heater to emit radiation. This can be by means of power cables 60 which may be connected, in use, to a battery 80 and/or other power supply e.g. a mains supply, and are connected by e.g. connectors 70 to the infrared heaters 40. The heaters 40,42 may be provided e.g. with pins 44 for electrical connection with the connectors 70. Other known types of electrical connection to a power supply are also possible. For reliability, the power supply to the heaters should be uninterrupted. In one example, therefore, the valve heating arrangement is provided with its own power source (e.g. battery 80) which can switch in to provide power if a main power supply is interrupted, to ensure uninterrupted power supply to the heaters. For additional reliability, the arrangement may be divided into two mirrored sub-systems 100, 200 (best seen in FIG. 6) each having its own power supply. In such an example, each subsystem may be designed such that one can provide sufficient heat in the event that the other is off.

In the example shown, heaters 40 are provided along the sides of the valve housing. In addition, or instead, heaters 42 could be provided in recesses 22 formed at the bottom of the valve housing (as seen in FIG. 3) and/or at the top of the valve housing, where space is typically available in the valve arrangement. Again, the recesses 22 should be provided with a transparent ‘window’ or cover 52 similar to the cover 50 described above.

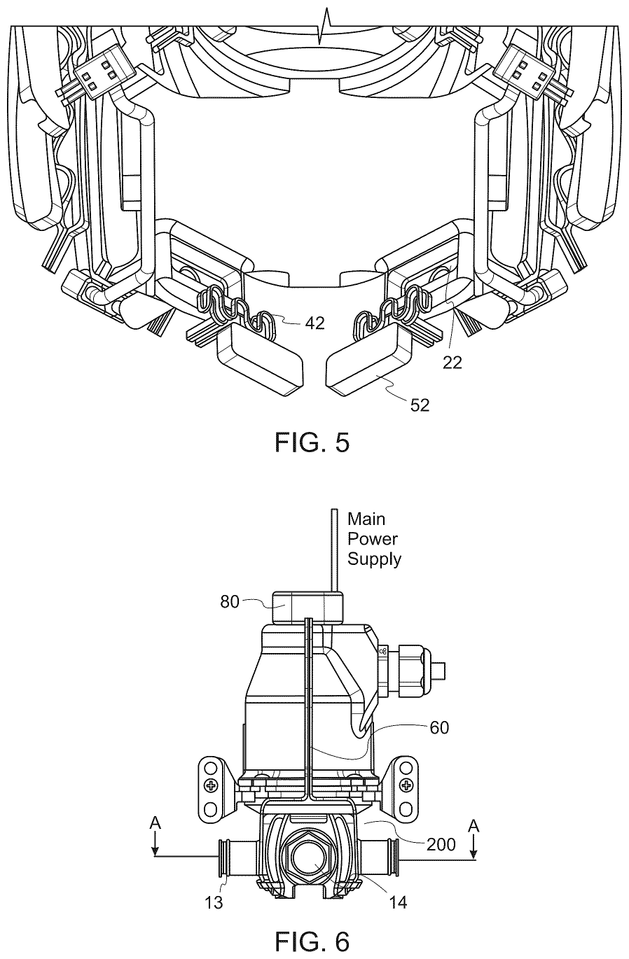

The various components of the above-described example can be more clearly seen in the exploded views of FIGS. 4 and 5.

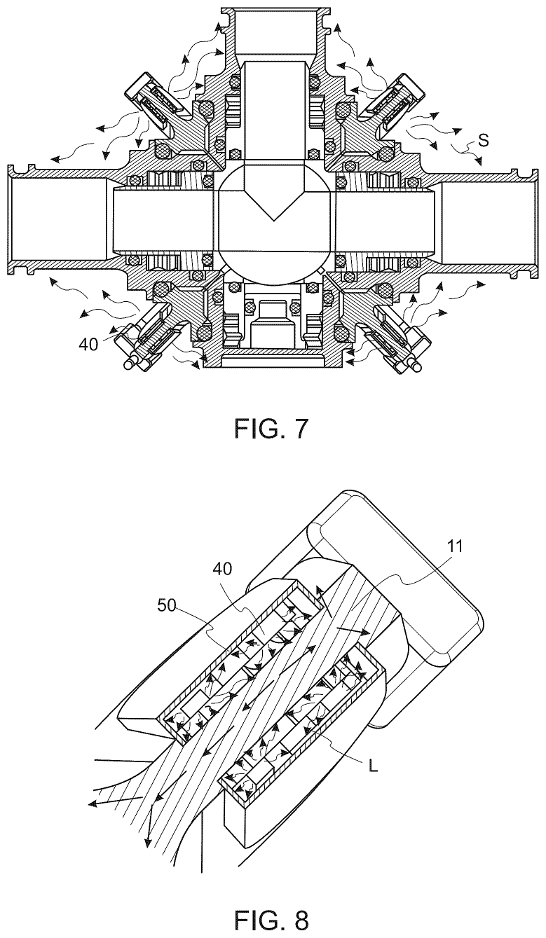

The heating operation of the arrangement of the disclosure will now be further described with reference to FIGS. 7 and 8.

FIG. 7 shows the arrangement through cross-section A-A of FIG. 6. The heaters 40 emit infrared radiation, when powered on, and radiation of the first wavelength range (near infrared/short-wave infrared) will pass through the transparent cover 50 and radiate around the exterior of the valve housing as indicated by the wavy arrows S. This radiation will warm objects into which it comes into contact, including the valve body 11, connectors 13 and plugs 14 connected to the valve. The infrared heaters in the enclosed recesses will also deliver heat to their surrounding and so will heat the inside of the recess and the transparent cover 50, using the principle of Joule heating or resistive heating. The heating arrangement provides three different heating effects. The radiation passing through the cover (arrows S shown in FIG. 7) will vary in amount depending on the cover material. Infrared radiation in the second range (mid/long-wave infrared) will be absorbed by the transparent material which itself becomes a source of heat which is conducted by it to provide conductive heating around the transparent material. Further, the heat generated by the heater in the recesses (arrows L in FIG. 8) will heat the material of the adjacent housing parts. As the housing is made of a heat conductive material, as it is heated by the radiation, the heat will be conducted throughout the housing and window material by conduction. Thus, heat is transferred to other areas that are not directly affected by infrared radiation (A and B). The combination of these heating effects means that the housing parts are heated and, also, a heating ‘zone’ is created around the housing parts, at least in the region of the heaters.

Because heat is generated using infrared heaters, which use less energy that other types of heaters, the heating arrangement is very energy efficient which makes it particularly advantageous in aircraft and the like where energy consumption must be minimised. Furthermore, the infrared heaters directly heat component parts and so energy is not wasted by heating surrounding air, and yet a warm zone can still be generated around the valve housing. Further, because radiant heat does not require a medium in which it propagates, it is an ideal solution for areas where there is no climate control and/or low air density such as at high altitudes.

Because the heating arrangement provides a heat zone, the heaters can be strategically placed to heat those parts of the system that are vulnerable to freezing—e.g. those subject to contact with water. Further, because the heaters are in enclosed recesses, they are less vulnerable to damage.

The heating arrangement is simple and inexpensive to manufacture and is easily scalable to different applications.

In recent times, additive manufacturing (or 3D printing) processes have been developed and improved to an extent that more and more components can be made in this way. Using additive manufacturing enables more flexibility in the sizes and more complexity in the shapes of components that can be manufactured. Desired shapes and sizes can be manufactured quickly and on an ‘as needed’ basis thus also reducing storage requirements. Additive manufacturing is now becoming a more common way of manufacturing valve bodies and valve parts. The solution provided here can take advantage of this development.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

1. A valve heating arrangement comprising:
one or more infrared heater elements; p1 a valve housing body comprising a heat conductive material,
wherein the one or more infrared heater elements are mounted into one or more enclosed recesses provided on or integrally formed with a valve housing body,
the one or more recesses having at least one wall defined by a closure of transparent material selected to allow infrared radiation of a first wavelength range to pass therethrough but to block passage of infrared radiation of a second, different, wavelength range from passing therethrough; and
means for providing power to the one or more infrared heating elements to emit infrared radiation across the first and second wavelength ranges.

2. The arrangement of claim 1, wherein the first wavelength range is in the near- or short-wave infrared radiation range.

3. The arrangement of claim 1, wherein the second wavelength range is in the mid- or long-wave infrared radiation range.

4. The arrangement of claim 1, wherein one or more of the recesses are provided in extensions or flanges of the housing body.

5. The arrangement of claim 4, wherein the valve housing body is substantially cuboid and the extensions or flanges are provided at each corner of the cube.

6. The arrangement of claim 4, wherein the extensions or flanges are attached to the housing body.

7. The arrangement of claim 4, wherein the extensions or flanges are formed integrally with the valve housing body.

8. The arrangement of claim 1, having two infrared heater elements provided in each recess.

9. The arrangement of claim 1, wherein the transparent material is glass.

10. The arrangement of claim 1, wherein the means for providing power comprises a battery or a mains power supply.

11. The arrangement of claim 1, wherein the housing body and heating elements and recesses are arranged as two mirrored subsystems, each having its own power supply.

12. The arrangement of claim 1, wherein one or more of the recesses are formed at a top or a bottom of the valve housing.

13. The arrangement of claim 1, the valve body housing and the recesses formed by additive manufacturing.

14. A valve assembly comprising:
a valve heating arrangement as claimed in claim 1;
an inlet port and an outlet port arranged to define a flow passage therebetween through the valve housing; and
a moveable valve element located in the flow passage and movable relative to the valve housing to regulate flow through the flow passage from the inlet port to the outlet port.
